(19) United States
(12) Patent Application Publication
(10) Pub. No.: US 2019/0235154 A1
(43) Pub. Date: Aug. 1, 2019

(54) BACKLIGHT UNIT, METHOD FOR MANUFACTURING THE SAME AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventor: Juan WANG, Beijing (CN)

(21) Appl. No.: 16/203,804

(22) Filed: Nov. 29, 2018

(30) Foreign Application Priority Data
Jan. 29, 2018 (CN) 201810083966.4

(51) Int. Cl. F21V 8/00; G02F 1/1333; G02F 1/1343

(52) U.S. Cl. CPC G02B 6/0073; G02F 1/133308; G02F 1/134309; G02F 1/13439; G02B 6/0055

(57) ABSTRACT

A backlight unit is provided. The backlight unit includes a light guide plate including a light exit surface, and at least one surface light source conformally provided on at least one surface of the light guide plate other than the light exit surface, respectively. Further, a method for manufacturing a backlight unit and a display device including the backlight unit are provided.

### CROSS-REFERENCE TO RELATED APPLICATIONS

The present application claims the priority of the Chinese Patent Application No. 201810083966.4, filed on Jan. 29, 2018, the contents of which are incorporated herein in their entirety by reference.

### TECHNICAL FIELD

The present disclosure relates to the field of display technology, and in particular, relates to a backlight unit, a method for manufacturing the same and a display device.

### BACKGROUND

A display device may include a backlight unit and a display panel provided on a light exit surface of the backlight unit. With the development of display technology, it is expected that the backlight unit is a surface light source with light of high uniformity emitted therefrom, and can be applied to a curved-screen display device and/or an ultra-thin display device.

### SUMMARY

Embodiments of the present disclosure provide a backlight unit, a method for manufacturing the same and a display device.

Some embodiments of the present disclosure provide a backlight unit, which including

a light guide plate including a light exit surface; and

at least one surface light source conformally provided on at least one surface of the light guide plate other than the light exit surface, respectively.

In an embodiment, each of the at least one surface light source includes a first electrode layer, a light emitting layer, and a second electrode layer which are stacked on top of each other.

In an embodiment, the light emitting layer contains a white light quantum dot material.

In an embodiment, the white light quantum dot material includes an II-VI quantum dot material.

In an embodiment, the II-VI quantum dot material includes one or more of CdMnS, CdSe and CdS.

In an embodiment, the white light quantum dot material includes CdSe and polymethyl methacrylate.

In an embodiment, the first electrode layer is provided between the light guide plate and the light emitting layer.

In an embodiment, the first electrode layer is a transparent electrode.

In an embodiment, the first electrode layer is made of indium tin oxide (ITO).

In an embodiment, the at least one surface light source includes only one surface light source conformally provided on a surface of the light guide plate opposite to the light exit surface or a lateral surface of the light guide plate substantially perpendicular to the light exit surface.

In an embodiment, the at least one surface light source includes two surface light sources conformally provided on two opposite lateral surfaces of the light guide plate substantially perpendicular to the light exit surface, respectively.

In an embodiment, the at least one surface light source includes three surface light sources conformally provided on a surface of the light guide plate opposite to the light exit surface and two opposite lateral surfaces of the light guide plate substantially perpendicular to the light exit surface, respectively.

In an embodiment, the at least one surface light source includes four surface light sources conformally provided on four lateral surfaces of the light guide plate substantially perpendicular to the light exit surface, respectively.

In an embodiment, the at least one surface light source includes five surface light sources conformally provided on a surface of the light guide plate opposite to the light exit surface and four lateral surfaces of the light guide plate substantially perpendicular to the light exit surface, respectively.

Some embodiments of the present disclosure provide a display device, which includes the backlight unit provided by any one of the embodiments of the present disclosure.

Some embodiments of the present disclosure provide a method for manufacturing a backlight unit. The method includes steps of

cleaning a light guide plate; and

forming coating layers constituting a surface light source on a surface of the light guide plate other than a light exit surface of the light guide plate conformally.

In an embodiment, the step of forming coating layers constituting a surface light source on a surface of the light guide plate other than a light exit surface of the light guide plate conformally includes steps of

forming a first electrode layer on the surface of the light guide plate other than the light exit surface of the light guide plate conformally;

forming a light emitting layer on the first electrode layer conformally; and

forming a second electrode layer on the light emitting layer conformally.

In an embodiment, the step of forming a light emitting layer on the first electrode layer conformally includes steps of

mixing a light emitting material and a film forming material together to form a coating material, wherein the light emitting material is a white light quantum dot material, and the film forming material is a resin material; and

spin coating the coating material on a surface of the first electrode layer conformally.

In an embodiment, the step of forming a first electrode layer on the surface of the light guide plate other than the light exit surface of the light guide plate conformally includes a step of

forming the first electrode layer by using a transparent electrode material.

In an embodiment, the step of forming the first electrode layer by using a transparent electrode material includes a step of

forming the first electrode layer by using indium tin oxide (ITO).

### BRIEF DESCRIPTION OF THE DRAWINGS

FIG. 1 is a schematic diagram showing a structure of a display device according to an embodiment of the present disclosure;

FIG. 2 is a schematic diagram showing a structure of a backlight unit according to an embodiment of the present disclosure;

FIG. 3 is a schematic diagram showing a structure of another backlight unit according to an embodiment of the present disclosure;

FIG. 4 is a schematic diagram showing a structure of still another backlight unit according to an embodiment of the present disclosure; and

FIG. 5 is a schematic flowchart showing a method for manufacturing a backlight unit according to an embodiment of the present disclosure.

### DETAILED DESCRIPTION

To make the objects, technical solutions and advantages of the present disclosure more clear, the present disclosure will be further described in detail below with reference to specific embodiments and the accompanying drawings.

It should be noted that, the terms “first”, “second”, and the like used herein are merely for the purpose of distinguishing one element from another element, and should not be construed as limiting an element following such a term. For example, a “first element” in one embodiment may be referred to as a “second element” in another embodiment, and vice versa.

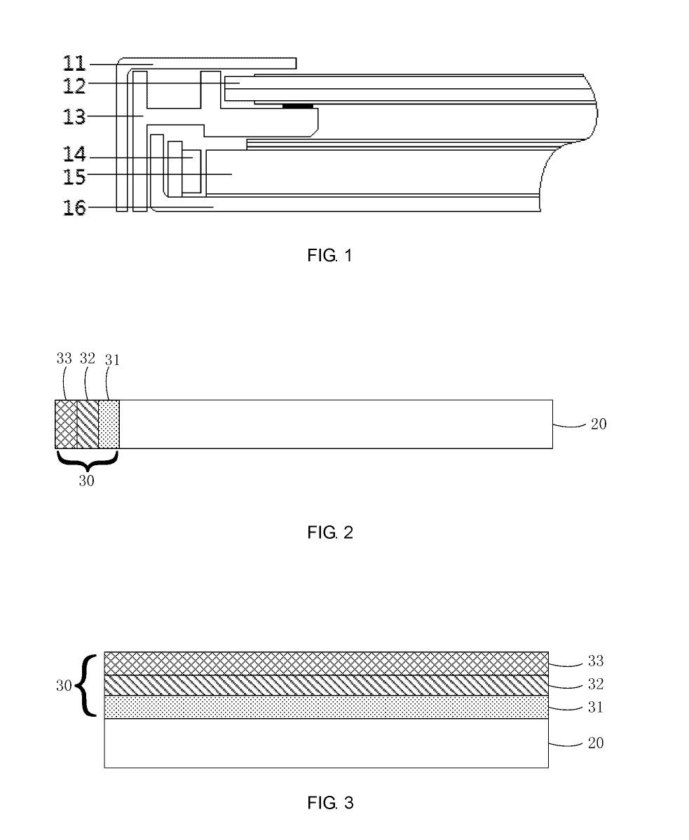

FIG. 1 is a schematic diagram showing a structure of a display device according to an embodiment of the present disclosure. As shown in FIG. 1, the display device may include a backlight unit and a display panel provided on a light exit surface of the backlight unit (e.g., an upper surface of a light guide plate 15 shown in FIG. 1). The backlight unit may include an LED strip light 14 and the light guide plate 15, and the LED strip light 14 may be provided on a lateral surface of the light guide plate 15 (e.g., the lateral surface may be substantially perpendicular to the light exit surface, as the left lateral surface of the light guide plate 15 shown in FIG. 1). The display panel may be a liquid crystal display panel 12. In addition, the display device may further include a bezel 11, a mold frame 13, and a back cover 16. The bezel 11, the mold frame 13, and the back cover 16 are configured to assemble the backlight unit and the display panel into the display device.

As shown in FIG. 1, the backlight unit is a side-entry backlight unit (i.e., light emitted from the backlight unit enters from a lateral surface of the light guide plate to the interior of the light guide plate). The LED strip light 14 may include a printed circuit board and a plurality of light emitting diodes (LEDs) mounted on the printed circuit board. The LED strip light 14 is attached to the back cover 16, and the light emitted from the LED strip light 14 is totally internal reflected in the light guide plate 15 to propagate forward (for example, towards the right side of FIG. 1). The light exit surface of the light guide plate 15 has a plurality of mesh points provided thereon. When the light propagating in the light guide plate 15 is incident on the mesh points provided on the light exit surface of the light guide plate 15, the total internal reflection of the light is destroyed, thus the light exits from the light exit surface of the light guide plate 15. The light emitted from the light exit surface of the light guide plate 15 may be further converged and diffused by an optical film to be distributed more uniformly, and then is incident on a light incident surface of the liquid crystal display panel 12 to enable the liquid crystal display panel 12 to achieve its normal display function.

In the present embodiment, the LED strip light 14 is relatively expensive. Further, the LED strip light 14 generally includes a plurality of LEDs, of which any two adjacent ones has a pitch (i.e., an interval) therebetween, and the pitch may cause a problem that a hot spot effect occurs when light propagates from the LED strip light 14 to a light incident surface of the light guide plate 15, and the light emitted from the light guide plate 15 has poor uniformity. Further, a proper distance between the light guide plate 15 and the LED strip light 14 is required, thus the backlight unit including the LED strip light 14 provided by the present embodiment may not have an advantage in implementing a curved-screen display device, for example, is not advantageous to realize an ultra-thin curved-screen display device. Moreover, as described above, since the LED strip light 14 generally includes a printed circuit board and a plurality of LEDs mounted on the printed circuit board, such that a shape of the LED strip light 14 may not match to a light incident surface of the light guide plate 15 very well.

An embodiment of the present disclosure provides a backlight unit that can improve a display effect.

The backlight unit may include a light guide plate having a light exit surface and at least one surface light source conformally provided on at least one surface of the light guide plate other than the light exit surface, respectively.

It can be seen from the above embodiment that, the backlight unit provided by the present embodiment can avoid an optical defect caused by the LEDs of the LED strip light 14, by replacing the LED strip light 14 provided by the embodiment corresponding to FIG. 1 with the surface light source. Further, a shape of the surface light source provided by the present embodiment can be matched with a shape of a light guide plate, such that the surface light source has great advantages in realization of a curved-screen display device (e.g., a curved-screen TV), and can realize an ultra-thin display device. In addition, without the LED strip light, the assembling of the backlight unit of the present embodiment is more convenient, and the assembling efficiency of the backlight unit is increased.

FIG. 2 is a schematic diagram showing a structure of a backlight unit according to an embodiment of the present disclosure, and the backlight unit can increase display performance.

The backlight unit includes a light guide plate (LGP) 20 having a light exit surface (e.g., an upper surface or a lower surface of the light guide plate 20 shown in FIG. 2) and a surface light source 30, which is conformally provided on a lateral surface of the light guide plate 20 (e.g., the left lateral surface of the light guide plate 20 shown in FIG. 2) other than the light exit surface. The surface light source 30 includes a first electrode layer 31, a light emitting layer 32, and a second electrode layer 33 which are stacked on top of each other. In an embodiment, the second electrode layer 33 may be made of any suitable metal.

It can be seen from the present embodiment that, in the backlight unit, by replacing the LED strip light 14 provided by the embodiment corresponding to FIG. 1 with the surface light source 30, optical defects (e.g., the hot spot effect, light emitted from the light guide plate has poor uniformity, and the like) can be avoided. Further, since the surface light source 30, substantially as a whole, is conformly provided on a lateral surface of the light guide plate 20 other than the light exit surface, the shape of the surface light source 30 can match to the shape of the light guide plate 20. That is, the entire lateral surface of the light guide plate 20 other than the light exit surface may be substantially covered by the surface light source 30. Therefore, the backlight unit has great advantages in realizing a curved-screen display device (e.g., a curved-screen TV), and can realize an ultra-thin display device. Furthermore, by adopting a structure including the first electrode layer 31, the light emitting layer 32 and the second electrode layer 33, when a suitable voltage is applied across the first electrode layer 31 and the second electrode layer 33, the light emitting layer 32 can be caused to emit light from an entire surface thereof, thereby realizing a better surface light source.

In some embodiments, the light emitting layer 32 contains a white light quantum dot material. Upon a suitable voltage is applied across the first electrode layer 31 and the second electrode layer 33, the resultant electric field excites the white light quantum dot material to emit white light, and then the white light exits from the light exit surface of the light guide plate and forms a surface light source, thereby providing a light source for a display panel such as a liquid crystal display (LCD) panel. Since the light emitting layer 32 is formed by using the white light quantum dot material, the shape of the surface light source 30 can well change according to the shape of the light guide plate 20, such that the surface light source 30 has great advantages in realizing a curved-screen display device (e.g., a curved-screen TV). In an embodiment, the white light quantum dot material includes any one or more of II-VI quantum dots such as CdMnS, CdSe, CdS, and the like. It should be noted that, the “II-VI” here refers to the Group II-VI in the periodic table of elements.

In one embodiment, the first electrode layer 31 is provided between the light guide plate 20 and the light emitting layer 32, and the first electrode layer 31 is a transparent electrode. Thus, by using the transparent electrode as the first electrode layer 31, the light emitted from the light emitting layer 32 may be transmitted to the light guide plate 20 efficiently. In an embodiment, the first electrode layer 31 is made of indium tin oxide (ITO).

FIG. 3 is a schematic diagram showing a structure of a backlight unit according to an embodiment of the present disclosure, and the backlight unit can improve display performance.

The backlight unit includes a light guide plate 20 having a light exit surface (e.g., a lower surface of the light guide plate 20 shown in FIG. 3) and a surface light source 30, which is conformally provided on a surface (e.g., an upper surface of the light guide plate 20 shown in FIG. 3) of the light guide plate 20 other than the light exit surface. The surface light source 30 includes a first electrode layer 31, a light emitting layer 32, and a second electrode layer 33 which are stacked on top of each other. The surface light source 30 may cover all or part of a light incident surface of the light guide plate 20. The light incident surface of the light guide plate 20 may be a surface of the light guide plate 20 provided with the surface light source 30, for example, the upper surface of the light guide plate 20 shown in FIG. 3.

It can be seen from the present embodiment that, in the backlight unit, optical defects (e.g., the hot spot effect, the light emitted from the light guide plate has poor uniformity, and the like) caused by the LEDs of the LED strip light 14 can be avoided, by replacing the LED strip light 14 provided by the embodiment of FIG. 1 with the surface light source. Further, since the surface light source 30 is conformly provided on a surface of the light guide plate 20 other than the light exit surface, the shape of the surface light source 30 can match to the shape of the light guide plate 20. Therefore, the backlight unit has great advantages in realizing a curved-screen display device (e.g., a curved-screen TV), and can realize an ultra-thin display device. Furthermore, by adopting a structure including the first electrode layer 31, the light emitting layer 32 and the second electrode layer 33, such that upon a suitable voltage is applied across the first electrode layer 31 and the second electrode layer 33, the light emitting layer 32 emits light from an entire surface thereof, thereby achieving a better surface light source. In addition, by providing the surface light source 30 on the light incident surface of the light guide plate 20, the light emitted from the surface light source 30 can be diffused by the light guide plate 20 more efficiently, and thus the light exiting from the light exit surface of the light guide plate 20 has a better uniformity.

In some embodiments, the light emitting layer 32 contains a white light quantum dot material. Upon a suitable voltage is applied across the first electrode layer 31 and the second electrode layer 33, the generated electric field excites the white light quantum dot material to emit white light, and then the white light exits from the light exit surface of the light guide plate and forms a surface light source, thereby providing a light source for a display panel such as a liquid crystal display (LCD) panel. Since the light emitting layer 32 is formed by using the white light quantum dot material, the shape of the surface light source 30 can well change according to the shape of the light guide plate, such that the surface light source 30 has great advantages in realizing a curved-screen display device (e.g., a curved-screen TV). In an embodiment, the white light quantum dot material includes any one or more of Group II-VI quantum dots such as CdMnS, CdSe, CdS, and the like.

In an embodiment, the first electrode layer 31 is provided between the light guide plate 20 and the light emitting layer 32, and the first electrode layer 31 is a transparent electrode. Thus, by using the transparent electrode as the first electrode layer 31, the light emitted from the light emitting layer 32 can be transmitted into the light guide plate 20 more efficiently. In an embodiment, the first electrode layer 31 is made of ITO.

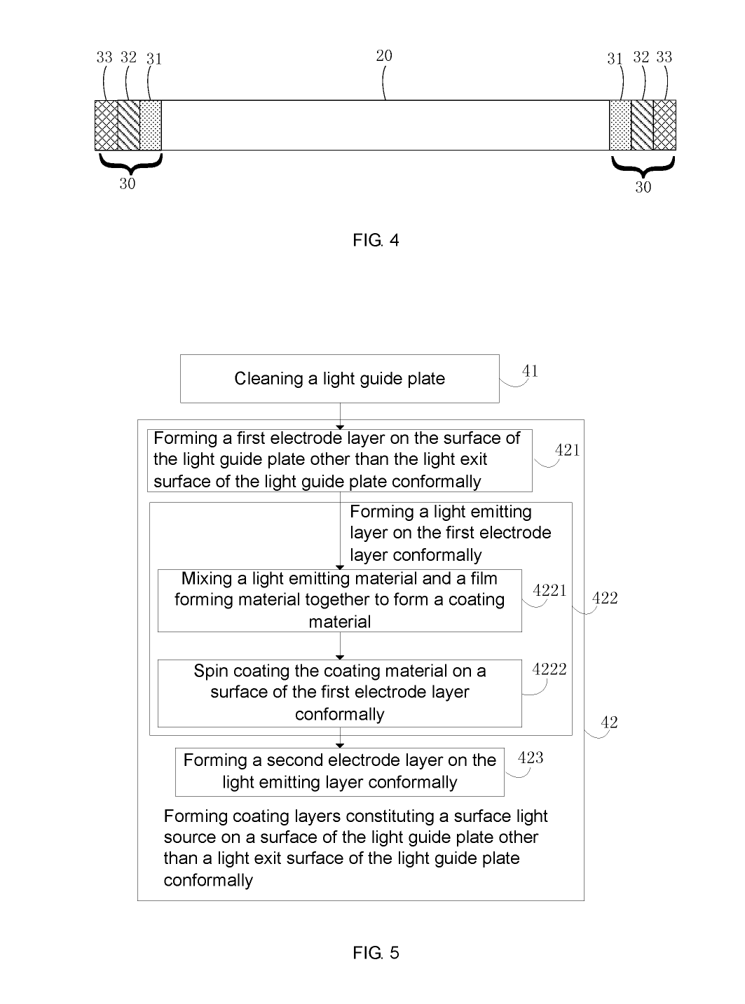

FIG. 4 is a schematic diagram showing a structure of a backlight unit according to an embodiment of the present disclosure, and the backlight unit can improve display performance.

The backlight unit includes a light guide plate 20 having a light exit surface (e.g., an upper surface or a lower surface of the light guide plate 20 shown in FIG. 4) and two surface light sources 30, which are conformally provided on two opposite lateral surfaces (e.g., a left lateral surface and a right lateral surface of the light guide plate 20 shown in FIG. 4) of the light guide plate 20 other than the light exit surface, respectively. Each of the surface light sources 30 includes a first electrode layer 31, a light emitting layer 32, and a second electrode layer 33 which are stacked on top of each other. In an embodiment, the light guide plate 20 may be a hexahedron, and the light exit surface of the light guide plate 20 may be an upper surface or a lower surface of the light guide plate 20 (e.g., the upper or lower surface of the light guide plate 20 shown in FIG. 4), and the light guide plate 20 includes four lateral surfaces that are substantially perpendicular to the light exit surface.

It can be seen from the present embodiment that, in the backlight unit, by replacing the LED strip light 14 provided by the embodiment corresponding to FIG. 1 with the surface light source 30, optical defects (e.g., the hot spot effect, the light emitted from the light guide plate has poor uniformity, and the like) caused by the LEDs can be avoided. Further, since the two surface light sources 30 are conformally provided on two opposite lateral surfaces of the light guide plate 20 other than the light exit surface, respectively, the shape of each of the surface light sources 30 can match to the shape of the light guide plate 20. Therefore, the backlight unit has great advantages in realizing a curved-screen display device (e.g., a curved-screen TV), and can realize an ultra-thin display device. Furthermore, by adopting a structure including the first electrode layer 31, the light emitting layer 32, and the second electrode layer 33, such that upon a suitable voltage is applied across the first electrode layer 31 and the second electrode layer 33, the corresponding light emitting layer 32 emits light from an entire surface thereof, thereby achieving a better surface light source. In addition, by arranging the two surface light sources 30 on two opposite lateral surfaces of the light guide plate 20, the uniformity of light emitted from the light exit surface of the light guide plate 20 is further increased.

In some embodiments, the light emitting layer 32 of each of the surface light sources 30 contains a white light quantum dot material, and an electric field generated after a suitable voltage is applied across the corresponding first electrode layer 31 and the corresponding second electrode layer 33 excites the white light quantum dot material to emit white light, and then the white light exits from the light exit surface of the light guide plate and forms a surface light source, thereby providing a light source for a display panel such as a liquid crystal display (LCD) panel. Since each of the light emitting layers 32 is formed by using the white light quantum dot material, so that the shape of each surface light source 30 can well change with the shape of the light guide plate 20, and the backlight unit has great advantages in realizing a curved-screen display device (e.g., a curved-screen TV). In an embodiment, the white light quantum dot material includes any one or more of Group II-VI quantum dots such as CdMnS, CdSe, CdS, and the like.

In an embodiment, for each surface light source 30, the first electrode layer 31 is provided between the light guide plate 20 and the light emitting layer 32, and the first electrode layer 31 is a transparent electrode. Thus, by using the transparent electrode as the first electrode layer 31, the light emitted from the light emitting layer 32 can be transmitted into the light guide plate 20 more efficiently. In an embodiment, each of the first electrode layers 31 is made of ITO.

In some embodiments, the light guide plate 20 may be a hexahedron. In this case, the light guide plate 20 has four lateral surfaces in addition to its upper and lower surfaces (e.g., the upper and lower surfaces shown in FIG. 4. of which one is a light exit surface). Four surface light sources 30 may be conformally provided on the four lateral surfaces of the light guide plate 20, respectively, so that the uniformity and the brightness of light emitted from the light exit surface of the light guide plate 20 can be further increased. In an embodiment, in addition to conformally providing the four surface light sources 30 on the four lateral surfaces of the light guide plate 20, respectively, a surface light source may be provided on a surface opposite to the light exit surface of the light guide plate 20, thereby further increasing the uniformity and the brightness of light emitted from the light exit surface of the light guide plate 20.

FIG. 5 is a schematic flowchart showing a method for manufacturing the backlight unit provided by an embodiment of the present disclosure. The backlight unit manufactured by the method can improve display performance.

As shown in FIGS. 2 to 5, the method for manufacturing the backlight unit may include the following steps 41 and 42.

Step 41 includes cleaning a light guide plate 20. For example, the light guide plate 20 may be a conventional light guide plate.

Step 42 includes forming coating layers constituting a surface light source on a surface of the light guide plate 20 other than a light exit surface of the light guide plate 20 conformally.

In an embodiment, the step 42 may include the following steps 421 to 423.

Step 421 includes forming a first electrode layer 31 on the surface of the light guide plate 20 conformally, such that the first electrode layer 31 may cover substantially the entire surface of the light guide plate 20.

Step 422 includes forming a light emitting layer 32 on the first electrode layer 31 conformally.

Step 423 includes forming a second electrode layer 33 on the light emitting layer 32 conformally. As such, by adopting a structure including the first electrode layer 31, the light emitting layer 32, and the second electrode layer 33, a better surface light source can be realized.

In an embodiment, the step 422 may include the following steps 4221 and 4222.

Step 4221 includes mixing a light emitting material and a film forming material together to form a coating material; the light emitting material is a white light quantum dot material, and the film forming material is a resin material. In an embodiment, the white light quantum dot material may be CdSe, and the film forming material may be polymethyl methacrylate (PMMA). The principle of light emission of such a hybrid white light quantum dot material including CdSe is as follows. The collapses of the internal lattice structure of the hybrid white light quantum dot material serve as intermediate states for transition of electrons, and electrons excited from a ground state to an excited state pass through different surfaces prior to returning to the ground state, and thus undergo a plurality of transitions from the intermediate states to the ground state, thereby emitting a series of visible light of different wavelengths. The combination of the visible light of different wavelengths results in white light.

Step 4222 includes spin coating the coating material on a surface of the first electrode layer 31 conformally. The so formed light emitting layer has good uniformity and can emit light having a better uniformity. In an embodiment, the first electrode layer 31 is made of ITO.

As can be seen from the present embodiment, in the manufacturing method, by replacing the LED strip light 14 provided by the embodiment corresponding to FIG. 1 with only one surface light source 30 which is formed on substantially an entire surface of the light guide plate 20 conformally, optical defects (e.g., the hot spot effect, light emitted from the light guide plate has poor uniformity, and the like) caused by the LEDs can be avoided. Further, since the surface light source 30 is conformally formed on the surface of the light guide plate 20, the shape of the surface light source 30 can be matched with the shape of the light guide plate 20. Therefore, the backlight unit manufactured by the method has great advantages in realizing a curved-screen display device (e.g., a curved-screen TV), and can realize an ultra-thin display device.

An embodiment of the present disclosure provides a display device that can improve display performance.

The display device includes the backlight unit provided by the embodiment corresponding to any one of FIGS. 2 to 4.

It should be noted that the display device according to the present embodiment may be any product or component having a display function, such as electronic paper, a mobile phone, a tablet computer, a television, a notebook computer, a digital photo frame, a navigator, and the like.

It can be seen from the present embodiment that, in the display device, by replacing the LED strip light 14 provided by the embodiment corresponding to FIG. 1 with the surface light source 30, optical defects (e.g., the hot spot effect, light emitted from the light guide plate has poor uniformity, and the like) caused by the LEDs can be avoided. Further, since the shape of the surface light source 30 can match to the shape of the light guide plate 20, the display device has great advantages in realizing a curved-screen display device (e.g., a curved-screen TV), and can realize an ultra-thin display device.

It should be noted that, the step of forming each layer of the surface light source 30 may include, but not limited to, chemical/physical phase deposition process or (magnetron) sputtering process. It should be understood by one of ordinary skill in the art that, after each layer is formed, a corresponding pattern may be further formed therefrom as needed, and detailed description thereof is omitted herein.

It should be further noted that, in the drawings, sizes of layers and regions may be exaggerated for clarity of illustration. Further, in a case where an element or layer is referred to as “on” another element or layer, it may be directly on the other element or layer, or an intermediate layer may be present. Further, in a case where an element or layer is referred to as being “under” another element or layer, it may be directly under the other element or layer, or at least one intermediate element or layer may be present. In addition, in a case where an element or layer is referred to as being “between” two elements or two layers, it may be a single element or layer between the two elements or the two layers, or at least one intermediate element or layer may be present. Like reference numerals indicate like elements throughout the disclosure.

It should be understood by one of ordinary skill in the art that, the above embodiments are only exemplary embodiments of the present disclosure, but are not intended to limit the present disclosure. Various improvements, equivalent replacement and modifications made without departing from the spirit and essence of the present disclosure also fall within the protection scope of the present disclosure.

What is claimed is:

1. A backlight unit, comprising
a light guide plate comprising a light exit surface; and
at least one surface light source conformally provided on at least one surface of the light guide plate other than the light exit surface, respectively.

2. The backlight unit according to claim 1, wherein each of the at least one surface light source comprises a first electrode layer, a light emitting layer, and a second electrode layer which are stacked on top of each other.

3. The backlight unit according to claim 2, wherein the light emitting layer contains a white light quantum dot material.

4. The backlight unit according to claim 3, wherein the white light quantum dot material comprises an II-VI quantum dot material.

5. The backlight unit according to claim 4, wherein the II-VI quantum dot material comprises one or more of CdMnS, CdSe and CdS.

6. The backlight unit according to claim 3, wherein the white light quantum dot material comprises CdSe and polymethyl methacrylate.

7. The backlight unit according to claim 1, wherein the first electrode layer is provided between the light guide plate and the light emitting layer.

8. The backlight unit according to claim 1, wherein the first electrode layer is a transparent electrode.

9. The backlight unit according to claim 8, wherein the first electrode layer is made of indium tin oxide (ITO).

10. The backlight unit according to claim 1, wherein the at least one surface light source comprises only one surface light source conformally provided on a surface of the light guide plate opposite to the light exit surface or a lateral surface of the light guide plate substantially perpendicular to the light exit surface.

11. The backlight unit according to claim 1, wherein the at least one surface light source comprises two surface light sources conformally provided on two opposite lateral surfaces of the light guide plate substantially perpendicular to the light exit surface, respectively.

12. The backlight unit according to claim 1, wherein the at least one surface light source comprises three surface light sources conformally provided on a surface of the light guide plate opposite to the light exit surface and two opposite lateral surfaces of the light guide plate substantially perpendicular to the light exit surface, respectively.

13. The backlight unit according to claim 1, wherein the at least one surface light source comprises four surface light sources conformally provided on four lateral surfaces of the light guide plate substantially perpendicular to the light exit surface, respectively.

14. The backlight unit according to claim 1, wherein the at least one surface light source comprises five surface light sources conformally provided on a surface of the light guide plate opposite to the light exit surface and four lateral surfaces of the light guide plate substantially perpendicular to the light exit surface, respectively.

15. A display device, comprising the backlight unit according to claim 1.

16. A method for manufacturing a backlight unit, comprising steps of
cleaning a light guide plate; and
forming coating layers constituting a surface light source on a surface of the light guide plate other than a light exit surface of the light guide plate conformally.

17. The method according to claim 16, wherein the step of forming coating layers constituting a surface light source on a surface of the light guide plate other than a light exit surface of the light guide plate conformally comprises steps of
forming a first electrode layer on the surface of the light guide plate other than the light exit surface of the light guide plate conformally;
forming a light emitting layer on the first electrode layer conformally; and
forming a second electrode layer on the light emitting layer conformally.

18. The method according to claim 17, wherein the step of forming a light emitting layer on the first electrode layer conformally comprises steps of
mixing a light emitting material and a film forming material together to form a coating material, wherein the light emitting material is a white light quantum dot material, and the film forming material is a resin material; and
spin coating the coating material on a surface of the first electrode layer conformally.

19. The method according to claim 17, wherein the step of forming a first electrode layer on the surface of the light guide plate other than the light exit surface of the light guide plate conformally comprises a step of
forming the first electrode layer by using a transparent electrode material.

20. The method according to claim 19, wherein the step of forming the first electrode layer by using a transparent electrode material comprises a step of
forming the first electrode layer by using indium tin oxide (ITO).
